(19) United States
(12) Patent Application Publication
(10) Pub. No.: US 2007/0054804 A1
(43) Pub. Date: Mar. 8, 2007

(54) Use of fungicides for disinfecting cereal seed

(75) Inventor: Anne Suty-Heinze, Langenfeld (DE)

Correspondence Address: STERNE, KESSLER, GOLDSTEIN & FOX PLLC, 1100 NEW YORK AVENUE, N.W., WASHINGTON, DC, 20005, US

(73) Assignee: BAYER CROPSCIENCE AKTIENGESELLSCHAFT, Monhiem (DE)

(21) Appl. No.: 10/570,945

(22) PCT Filed: Aug. 31, 2004
(86) PCT No.: PCT/EP04/09672

§ 371 Date: Oct. 3, 2006

(30) Foreign Application Priority Data
Sep. 11, 2003 (DE) 10341945.4

(51) Int. Cl. A01N 25/26; A01N 43/50; A01N 43/64

(52) U.S. Cl. 504/100; 514/383; 514/397

(57) ABSTRACT

The use of active compound combinations comprising prothioconazole and tebuconazole for dressing seed against attack by phytopathogenic fungi.

The invention relates to the use of fungicidal compositions comprising prothioconazole and tebuconazole for dressing seed.

It is already known that active compound combinations comprising prothioconazole and tebuconazole can be used as compositions for controlling phytopathogenic fungi, inter alia for dressing cottonseed (cf. EP-B 0 975 219). However, the specific use of such preparations for treating cereal seed, i.e. for dressing seed of monocotyledonous plants, has hitherto not been described.

It has now been found that active compound combinations comprising

prothioconazole and

tebuconazole

are highly suitable for dressing cereal seed against attack by phytopathogenic fungi.

Surprisingly, the fungicidal action of the active compound combinations which can be used according to the invention is, in the treatment of seed, considerably higher than the sum of the activities of the individual active compounds. Thus, an unforeseeable true synergistic effect is present, and not just an addition of activities.

Prothioconazole and its use as fungicide are known (cf. WO 96-16 048). This active compound is 2-[2-(1-chlorocyclopropyl)-3-(2-chlorophenyl)-2-hydroxypropyl]-2,4-dihydro[1,2,4]-triazole-3-thione which can be present both in the “thiono” form of the formula 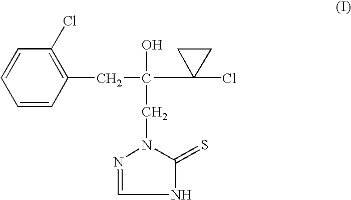
and in the tautomeric “mercapto” form of the formula

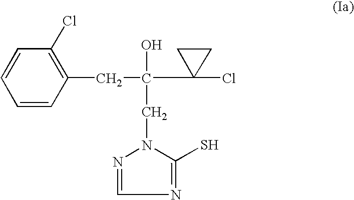

Tebuconazole and its use as fungicide are likewise known (cf. EP-A 0 040 345). This active compound is the triazole derivative of the formula

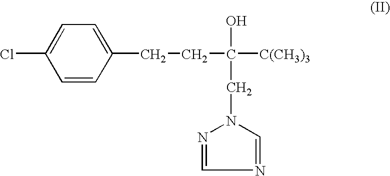

The synergistic effect is particularly pronounced if the active compounds are present in the active compound combinations to be used according to the invention in certain weight ratios. However, the weight ratios of the active compounds in the active compound combinations can be varied within a relatively wide range. In general, from 0.01 to 100 parts by weight, preferably from 0.05 to 20 parts by weight, of tebuconoazole are present per part by weight of prothioconazole.

In addition to prothioconazole and tebuconazole, the active compound combinations to be used according to the invention may also comprise further active compounds.

The active compound combinations to be used according to the invention have very good fungicidal properties and can be used for controlling phytopathogenic fungi, such as Plasmodiophoromycetes, Oomycetes, Chytridiomycetes, Zygomycetes, Ascomycetes, Basidiomycetes, Deuteromycetes etc. They are particularly suitable for controlling cereal diseases, such as Tilletia, Ustilago and Fusarium.

The active compound combinations to be used according to the invention can be converted into the customary seed dressing formulations, such as solutions, emulsions, suspensions, powders, foams, slurries or other coating materials for seed, and also ULV formulations.

These formulations are prepared in a known manner by mixing the active compounds or active compound combinations with customary additives, such as, for example, customary extenders and also solvents or diluents, colorants, wetting agents, dispersants, emulsifiers, defoamers, preservatives, secondary thickeners, adhesives, gibberellins and water as well.

Suitable colorants that may be present in the seed dressing formulations to be used according to the invention include all colorants customary for such purposes. Use may be made both of pigments, of sparing solubility in water, and of dyes, which are soluble in water. Examples that may be mentioned include the colorants known under the designations Rhodamin B, C.I. Pigment Red 112 and C.I. Solvent Red 1.

Suitable wetting agents that may be present in the seed dressing formulations to be used according to the invention include all substances which promote wetting and are customary in the formulation of agrochemically active compounds. Preference is given to using alkylnaphthalenesulfonates, such as diisopropyl- or diisobutylnaphthalenesulfonates.

Suitable dispersants and/or emulsifiers that may be present in the seed dressing formulations to be used according to the invention include all nonionic, anionic and cationic dispersants which are customary in the formulation of agrochemically active compounds. Preference is given to using nonionic or anionic dispersants or mixtures of nonionic or anionic dispersants. Particularly suitable nonionic dispersants are ethylene oxide/propylene oxide block polymers, alkylphenol polyglycol ethers, and also tristryrylphenol polyglycol ethers and their phosphated or sulfated derivatives. Particularly suitable anionic dispersants are lignosulfonates, polyacrylic acid salts and arylsulfonate/formaldehyde condensates.

Defoamers that may be present in the seed dressing formulations to be used according to the invention include all foam-inhibiting compounds which are customary in the formulation of agrochemically active compounds. Preference is given to using silicone defoamers and magnesium stearate.

Preservatives that may be present in the seed dressing formulations to be used according to the invention include all compounds which can be used for such purposes in agrochemical compositions. By way of example, mention may be made of dichlorophen and benzyl alcohol hemiformal.

Suitable secondary thickeners that may be present in the seed dressing formulations to be used according to the invention include all compounds which can be used for such purposes in agrochemical compositions. Preference is given to cellulose derivatives, acrylic acid derivatives, xanthan, modified clays and finely divided silica.

Suitable adhesives that may be present in the seed dressing formulations to be used according to the invention include all customary binders which can be used in seed dressings. Polyvinylpyrrolidone, polyvinyl acetate, polyvinyl alcohol and tylose may be mentioned as being preferred.

Suitable gibberellins that may be present in the seed dressing formulations to be used according to the invention preferably include compounds of the formula 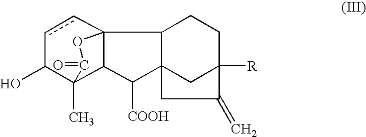
in which
R represents a hydrogen atom or a hydroxyl group and
the dashed line indicates that at the position of the ring either a C—C single bond or a C═C double bond is present.

Examples that may be mentioned of gibberellins of the formula (III) include the following:

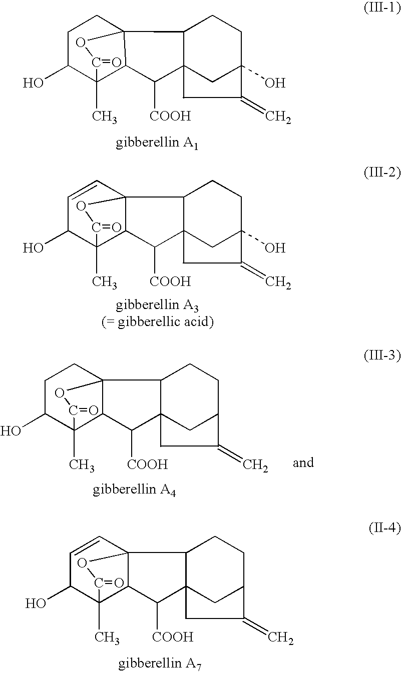

Particular preference is given to gibberellic acid of the formula (III-2).

The gibberellins of the formula (III) are known (cf. R. Wegler “Chemie der Pflanzenschutz- und Schädlingsbekämpfungsmittel”, volume 2, Springer Verlag, Berlin-Heidelberg-New York, 1970, pages 401-412).

The seed dressing formulations to be used according to the invention are used either directly or after prior dilution with water for the treatment of cereal seed of various types. Thus, the concentrates or the preparations obtainable therefrom by dilution with water can be used for dressing the seed of wheat, barley, rye, oats, millet, spelt, triticale, corn and rice. The seed dressing formulations to be used according to the invention or dilute preparations thereof can also be used for dressing seed of transgenic plants. In this context, additional synergistic effects may also arise in interaction with the substances formed by expression.

Suitable mixing equipment for treating seed with the seed dressing formulations to be used according to the invention or the preparations prepared therefrom by addition of water includes all mixing equipment which can commonly be used for dressing. The specific procedure adopted when dressing comprises introducing the seed into a mixer, adding the particular desired amount of seed dressing formulations, either as such or after prior dilution with water, and carrying out mixing until the formulation is uniformly distributed on the seed. If appropriate, this is followed by a drying operation.

The application rate of the seed dressing formulations to be used according to the invention may be varied within a relatively wide range. It depends on the respective content of the active compounds in the formulations and on the seed. In general, the application rates of active compound combination are between 0.001 and 50 g per kilogram of seed, preferably between 0.01 and 15 g per kilogram of seed.

The good fungicidal action of the active compound combinations to be used according to the invention for the treatment of seed is demonstrated by the examples below. Whereas there are deficits in the fungicidal action of the individual active compounds, the combinations show an activity which exceeds a simple addition of activities.

In fungicides, a synergistic effect is always present when the fungicidal activity of the active compound combinations exceeds the total of the activities of the active compounds when applied individually.

The expected activity for a given combination of two active compounds can be calculated according to S. R. Colby (“Calculating Synergistic and Antagonistic Responses of Herbicide Combinations”, Weeds 15 (1967), 20-22) as follows:

if

X is the efficacy when applying active compound A at an application rate of mg/100 kg,
Y is the efficacy when applying active compound B at an application rate of ng/100 kg and
E is the efficacy when applying the active compounds A and B at application rates of m and ng/100 kg, respectively,
then

$$E = X + Y - \frac{X \cdot Y}{100}$$

The efficacy is calculated in %. 0% means an efficacy which corresponds to that of the control, whereas an efficacy of 100% means that no infection is observed.

If the actual fungicidal activity exceeds the calculated value, then the activity of the combination is superadditive, i.e. a synergistic effect is present. In this case, the efficacy which was actually observed must be greater than the value for the expected efficacy (E) calculated from the above formula.

The invention is illustrated by the examples below.

### EXAMPLE 1

### Fusarium nivale Test (Wheat)/Seed Treatment

The active compounds or the active compound combination are/is applied using commercially available liquid seed dressings of the individual active compounds or the active compound combination.

For seed dressing, the infected seed is shaken with the seed dressing in question in a closed plastic container for 3 minutes.

For each test, in two seed trays in each case 100 wheat corns are sown at a depth of 3 cm in sand and covered with a layer of fine particulate clay. The seed trays are then placed in a greenhouse at a temperature of about 10° C. and a relative atmospheric humidity of 95% and exposed to light for 15 hours per day.

Three weeks after sowing, the plants are evaluated for symptoms. The efficacy is expressed in %. 0% means an efficacy which corresponds to that of the control, whereas an efficacy of 100% means that no infection is observed.

Active compounds, active compound concentrations and test results are shown in the table below.

TABLE 1
Fusarium nivale test (wheat)/seed treatment

| | | Active compound | | | |
|---|---|---|---|---|---|
| Active compound/active | | application rate in g | | | |
| compound combination | | per 100 kg of seed | | Efficacy in % | |
| Known: | | | | | |
| tebuconazole | | 3 | | 11 | |
| prothioconazole | | 5 | | 57 | |
| According to the invention: | | | | found | calculated*) |
| tebuconazole | | 3 | | | |
| + | {close oversize brace} | + | {close oversize brace} | 87 | 62 |
| prothioconazole 1:1.7 | | 5 | | | |

*)calculated using Colby's formula

1. The use of active compound combinations comprising
prothioconazole and
tebuconazole
for dressing cereal seed.

2. The use as claimed in claim 1, characterized in that active compound combinations comprising from 0.01 to 100 parts by weight of tebuconazole per part by weight of prothioconazole are used.

3. A method for protecting cereal seed against attack by phytopathogenic fungi, characterized in that seed is treated with active compound combinations comprising
prothioconazole and
tebuconazole.
